(19) United States
(12) Patent Application Publication
(10) Pub. No.: US 2003/0219251 A1
(43) Pub. Date: Nov. 27, 2003

(54) Wireless optical system and method for point-to-point high bandwidth communications

(76) Inventors: Sam Eric McMurry, Richardson, TX (US); Harry Littlejohn, Highland Village, TX (US)

Correspondence Address: FISH & RICHARDSON P.C., 5000 BANK ONE CENTER, 1717 MAIN STREET, DALLAS, TX, 75201, US

(21) Appl. No.: 10/409,918

(22) Filed: Apr. 9, 2003

Related U.S. Application Data
(60) Provisional application No. 60/371,694, filed on Apr. 10, 2002.

(51) Int. Cl. H04B 10/04

(52) U.S. Cl. 398/58

(57) ABSTRACT

An optical communications system and method for point-to-point high bandwidth communications are disclosed. The system and method of the present invention employ intelligent, adaptive software to establish and maintain over time a communications link between two or more optical devices without the need for wiring or additional hardware (e.g., lens systems). In one embodiment, beam position information is relayed between optical devices to maintain alignment of the beam. The use of weighted data quality measurements optimizes the acquisition and maintenance of the optical communications link. Beam drift and movement are counteracted with the application of forces to one or more of the optical devices. The system is a cost-effective optical communications system capable of providing network connectivity in an enterprise environment (e.g., office or warehouse); ease of initial deployment; adequate security; safety (e.g., via use of low power lasers and/or LEDs); ease of reconfiguration; and useful communication range

### CROSS-REFERENCE TO RELATED APPLICATIONS

This application claims the benefit of co-pending U.S. Provisional Application Serial No. 60/371,694, entitled “Wireless Optical System for Point to Point High Bandwidth Communications,” filed Apr. 10, 2002; and is related to co-pending applications:

U.S. patent application Ser. No. 10/090,249, entitled “Wireless Optical System For High Bandwidth Communications,” filed Mar. 4, 2002; and

U.S. patent application Ser. No. 10/090,270, entitled “Wireless Optical System For Multidirectional High Bandwidth Communications,” filed Mar. 4, 2001,

all of which are hereby incorporated herein by reference.

### TECHNICAL FIELD

This invention relates to wireless networking, and more particularly to a wireless optical system and related method for point-to-point high bandwidth communications.

### BACKGROUND

The ubiquity of computers in modem enterprises has given rise to the need for options to network such computers, both internally and with the outside world. Historical options for network connection systems include the use of Category 5 (or higher) wiring (CAT 5) and radio frequency (RF) modules for connecting computers to a local area network (LAN), typically including the use of a network hub (e.g., Ethernet).

Each of the above-identified network communication systems has associated disadvantages. For example, the use of CAT 5 wiring can provide a relatively secure connection between the users and the hub(s). However, the frequent reconfiguration of physical spaces (e.g., offices and cubicles) within enterprises often necessitates rewiring, producing additional expense and costly down time for the enterprise. And while the use of RF LAN cards for network connections relieves the need for rewiring, RF LAN card options are susceptible to external monitoring with relatively modest effort, compromising the security of connections produced with this option.

More recent options for computer networking include the use of optical systems, such as optical infrared connections. However, such systems typically suffer from low data rates and low power, producing only limited functionality. With such limitations, these types of systems are only suited for close-proximity (up to several feet) applications.

Optical communication systems that can cover greater distances typically utilize large powerful beams, small beams with large lenses, or small beams with the addition of many light detectors to keep the smaller beam aligned. An example of the beam of this prior art type of system is illustrated in FIG. 1. The optical communication system shown utilizes a beam with a large diameter and/or divergence. Using a large diameter beam 102 provides a large tolerance for positioning the beam on an optical detector 104 of a receiving unit (not shown). This type of prior art system requires large optics or focusing optics and a high power laser to provide sufficient optical energy to the optical detector 104, producing a number of significant drawbacks, such as: (a) inefficiency due to loss of a great deal of the optical energy not utilized; (b) danger associated with use of large powerful beams hazardous to eyesight; and (c) low sensitivity since the optical energy is spread across an area much larger than the detector.

A second type of prior art optical communication system is used to address the presence of environmental factors, such as atmospheric turbulence/attenuation or base motion and vibration. As shown in FIG. 2, this type of optical communication system uses a large lens system in an effort to focus the energy onto a data detector 206. The large collecting lens 202 allows for a relatively large tolerance for positioning a beam 204 on a detector 206 of a receiving unit since the lens will focus the optical energy onto the detector 206. However, one downside associated with this type of system is the need for expensive and bulky optics and focusing mechanisms.

A third type of prior art optical communication system is also used to address environmental factors. This type of system utilizes supplemental or positioning signal detectors, as outlined in more detail in U.S. Published Application 2002/0054411 and U.S. Published Application 2002/0181055). An example of such supplemental signal detectors is illustrated in FIG. 3. Referring now to FIG. 3, the system includes positioning sensors, 302, 304, 306, and 308 that are located near a primary data detector 310. The position of the received beam relative to the data detector 310 may be computed directly from the analog measurement of the sensors 302, 304, 306, and 308. This type of system requires the use of four additional detectors and their associated hardware as well as software to support the use and calibration of the sensors. Therefore, one significant downside associated with this type of prior art system is the expensive of additional hardware and software.

There exist other environmental factors (e.g., vibration and temperature) that can cause optical beams to “drift” over time. In the above-identified systems discussed with reference to FIGS. 1 and 2, an additional mechanism is usually required to maintain alignment between a transmitter and a receiver (i.e., to compensate for movement and component drift). Typical alignment mechanisms include components utilizing servomechanisms to mechanically maintain the proper alignment between the transmitter and receiver pair(s). Relatively low-tech in operation, this type of alignment mechanism is used because the optical signals typically exhibit wide dispersion, precluding a large percentage of transmitted light from reaching the remote receiver. Even when the transmitting beam is centered, this type of system does not supply a large amount of its overall light output to the optical receiver due to both the size of the dispersed beam relative to the size of the receiving element, and because of the existence of atmospheric disturbances (e.g., dust and humidity). The prior art system discussed in connection with FIG. 3, however, is useful for initial beam positioning, but lacks the ability to address beam drift.

As illustrated above with respect to prior art optical communication systems, there remains a need for a cost effective optical communications system capable of providing network connectivity in an enterprise environment (e.g., office or warehouse) that includes: ease of initial deployment; adequate security; safety (e.g., via use of low power lasers and/or LEDs); ease of reconfiguration, and useful communication range.

### SUMMARY

The optical communication system and method of the present invention fulfills the needs outlined above. An embodiment of the present invention is a system and method of establishing alignment between a first optical device and a second optical device. Prior art methods comprise the steps of: (1) transmitting a signal including beam position information for the second optical device; (2) receiving a signal including beam position information from the second optical device; (3) analyzing beam position information from the second optical device; and (4) directing a transmitting beam based on beam position information from the second optical device. Such prior art method is effective at shorter ranges (<50 meters) only if the beam has a uniform energy distribution. Extensions provided by the present invention system and method overcome these limitations by including the additional steps of: (a) estimating the quality of the data transmission; and (b) applying methods to optimize the position of the beam on the second detector unit.

An alternative embodiment of the system and method of the present invention comprises a system and method of maintaining alignment between a first optical device and a second optical device. The method comprises the steps of: (1) sending positioning information from the first optical device to the second optical device at a predetermined rate; (2) receiving positioning information from the second optical device at a predetermined rate; (3) analyzing the received positioning information from the second optical device to determine whether the beam drift or movement is occurring; and (4) if drift or motion is detected, taking corrective action to realign the beam.

The above-identified embodiments have several advantages over the prior art fixed infrastructure network systems, including speed of deployment, cost efficiency, flexibility of structure and reconfiguration, security of data transmission, and stability (e.g., very low bit error rates). Some embodiments provide a means to overcome the limitations of costs associated with the physical wiring, the labor to reroute wiring, and the limitations of where wiring can be quickly deployed when wired networking is used to connect users on a network.

Some embodiments of the present invention also provide for the transmission and reception of data in a wireless environment at relatively great distance (>100 meters), based on information carried on light signals from laser sources or light emitting diodes to receiving laser or diode detectors. These embodiments are particularly well suited for establishing high integrity and high information bandwidth links in high clutter environments, such as inside buildings, near complex foliage or landscaping, or in complex urban environments where the installation of wiring is not cost effective or cannot be accomplished in timely manner.

The details of one or more embodiments of the present invention system and method are set forth in the accompanying Drawings and the Detailed Description set forth below. Other features, objects, and advantages of the invention will be apparent from the Detailed Description and Drawings, and from the claims.

### DESCRIPTION OF DRAWINGS

The FIGURES outlined below further illustrate the apparatus and method of the present invention. Like reference symbols in the various drawings indicate like elements.

FIG. 1 is a cross sectional view of the beam of a prior art optical communication system including a light-detecting element with a large beam aimed at a detecting element;

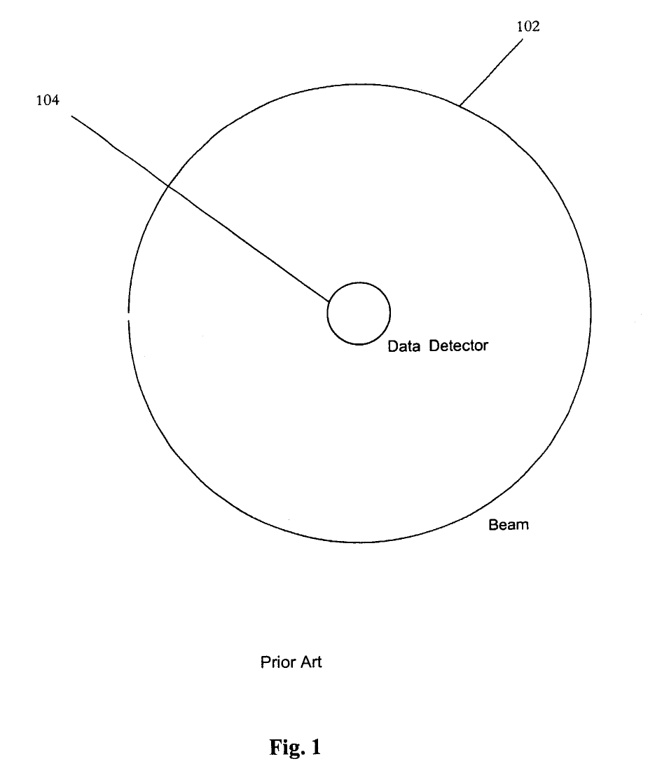

FIG. 2 is a front view of a prior art optical communication system including a light detecting element and a focusing lens with a beam aimed at the lens;

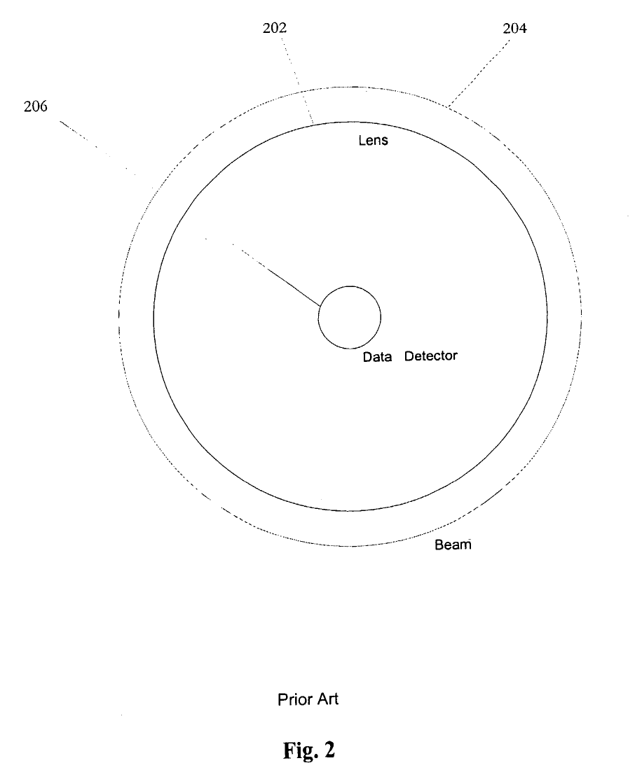

FIG. 3 is a cross sectional view of a prior art optical communication system including a light detecting element and supplemental peripheral detecting elements;

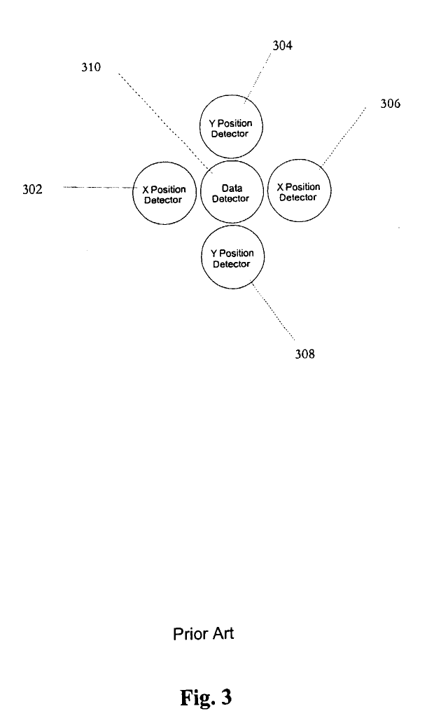

FIG. 4 is a diagram illustrating one embodiment of the optical communication system of the present invention;

FIG. 5 is a diagram of an alternative embodiment of the optical communications system of the present invention illustrating incorporation of a separate network management system;

FIG. 6 is a block diagram of one embodiment of the optical communications system of the present invention;

FIG. 7 is an illustration of one embodiment of a control packet structure used in connection with the optical communications system of the present invention;

FIG. 8 is a flow diagram illustrating one embodiment of the optical communications method of the present invention;

FIG. 9 is a view illustrating an exemplary registration pattern made from a transmitter of one embodiment of the optical communications system of the present invention;

FIG. 10A is a view illustrating relative positions between transmitter beams and data detectors in one embodiment of the optical communications system of the present invention;

FIG. 10B is a representation of a deformed beam shape;

FIG. 10C is a representation of a uniform beam shape with a non-uniform data quality distribution;

FIG. 11 is a flow diagram illustrating a sub-process used by one embodiment of the optical communications method of the present invention;

FIG. 12 is a flow diagram illustrating a sub-process used by one embodiment of the optical communications method of the present invention during a post-acquisition phase;

FIG. 13 is a flow diagram illustrating a sub-process used by one embodiment of the optical communications method of the present invention during a tracking phase;

FIG. 14 is a flow diagram illustrating a sub-process used by one embodiment of the optical communications method of the present invention;

FIG. 15 is a flow diagram illustrating an embodiment of the optical communications method of the present invention;

FIG. 16 illustrates a pattern of beam movement used by one embodiment of the optical communications system and method of the present invention for calibration;

FIG. 17 illustrates an alternative pattern of a beam movement used by one embodiment of the optical communications system and method of the present invention for calibration;

FIG. 18 illustrates an alternative pattern of a beam movement used by one embodiment of the optical communications system of the present invention for calibration;

FIG. 19A illustrates an alternative pattern of a beam movement used by one embodiment of the optical communications system and method of the present invention for calibration;

FIG. 19B illustrates an alternative pattern of beam movement used by one embodiment of the optical communications system and method of the present invention for scanning;

FIG. 19C illustrates an alternative pattern of beam movement used by one embodiment of the optical communications system and method of the present invention for scanning;

FIG. 20 is a graph showing the relationship between dynamic quality gates set according to the range of two units;

FIG. 21 is an illustration of a configuration of three connect units of one embodiment of the optical communications system and method of the present invention;

FIG. 22 is a flow diagram illustrating one embodiment of the optical communications method of the present invention for discriminating between two units;

FIG. 23 is a diagram showing drift positions of a beam;

FIG. 24 is a top view of one embodiment of the optical communications system of the present invention showing use of a corner reflector as an aid in pointing and acquisition;

FIG. 25 is a top view of one embodiment of the optical communications system of the present invention showing use of a corner reflector as an aid in pointing and acquisition;

FIG. 26 is a block diagram illustrating an alternative embodiment of the optical communications system of the present invention; and

FIG. 27 is a front view of one embodiment of the optical communications system of the present invention showing use of two positioning detectors.

Like reference symbols in the various drawings indicate like elements.

### DETAILED DESCRIPTION

A preferred embodiment of the optical communications system and method of the present invention provides a unique method and system for performing optical communications with high bandwidth and extended range between two access points in a network. It is noted, however, that additional embodiments exist, as specifically outlined herein, and additional ones as one skilled in the art will readily appreciate. Specific examples of components, signals, messages, protocols, and arrangements described herein are presented to simplify the disclosure, and not intended as limitations on the claimed invention. Well-known elements are presented without detailed description in order to simplify the disclosure. Details unnecessary to obtain a complete understanding of the present invention have been omitted inasmuch as such details are within the scope of persons of ordinary skill in the relevant art. For example, details regarding control circuitry or mechanisms used to control the various elements described herein are omitted, as such control circuits are within the skills of person of ordinary skill in the relevant art.

An embodiment of the optical communications system and method of the present invention relates to establishing optical communication between pairs of devices, and can be thought of as a general replacement for Category 5 or 5e networking cable system, which is used for Ethernet networking, at distances up to 100 meters. A significant advantage associated with use of this embodiment is the ability to use cost effective laser sources that may not have uniform energy distributions in the beam. In this embodiment, each single device may have an optical transmitter and receiver, which are used to provide two optical paths that enable bidirectional data flow between the pair of devices. Each device may also have a separate electrical networking connection that is used to connect to a standard Ethernet network. Data is passed transparently between the electrical and optical networking connections on each device in both directions.

A pair of the devices will communicate with each other as well as passing data transparently and bi-directionally between the electrical networking ports of each device. The communication between the devices serves primarily to establish and maintain an optical link. Some embodiments of the present invention can also be managed as a standard piece of networking equipment providing industry standard control and statistical information, as well as control and statistics specific to the invention.

Previous prior art systems and methods of providing optical data links have relied on one or some combination of three techniques (large divergence of the transmitted beam, large receiver optics, and supplemental positioning detectors) to overcome environmental conditions that would otherwise render an optical path unusable. Conditions such as temperature variations, atmospheric disturbances, and base vibrations can affect the positioning of optical beams, as well as the quality of data being transmitted across such beams.

Embodiments of the optical communications system and method of the present invention, by contrast, provide reliable, high speed optical links without the use of any of these prior art techniques, resulting in a simpler, more flexible and cost effective design. Advantages over the prior art exhibit by the optical communications system and method of the present invention flow from its reliance on intelligent, adaptive, software solutions versus costly, bulky, and complex hardware solutions. One embodiment of the optical communications system and method of the present invention incorporates as a basis the teachings of co-pending U.S. Ser. No. 10/090,249 to provide enhanced performance in the presence of external error sources.

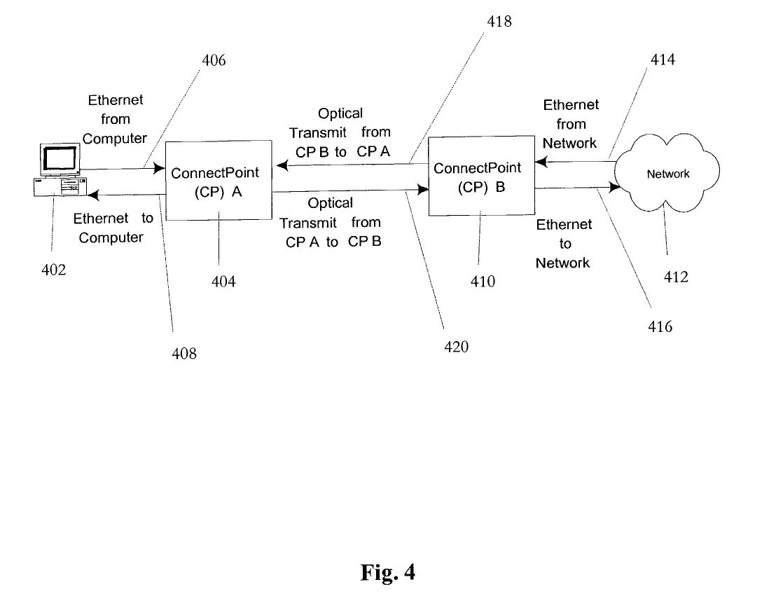

Turning now to FIG. 4, there is illustrated a diagram of one embodiment of the optical communication system of the present invention. An end user computer 402 is in communication with a connect unit A 404 via a conventional connection illustrated by communication links 406 and 408. Similarly, a connect unit B 410 is in communication with a network 412 via a conventional connection illustrated by communication links 414 and 416. In this embodiment, the connect unit A 404 and the connect unit B 410 communicate with each other via optical signals, which are represented as communication links 418 and 420 respectively.

Relative to the connect unit A 404, the connect unit B 410 is the “opposite unit.” Similarly relative to the connect unit B 410, the connect unit A 404 is the “opposite unit.” In this embodiment, the communication link 418 represents an optical signal transmitted from the connect unit B 410 and received by the connect unit A 404. Similarly, the communication link 420 represents an optical signal transmitted by the connect unit A 404 and received by the connect unit B 410. Thus, the end user computer 402 may communicate with the network 412 via the connect units A 404 and connect unit B 410 over communication links 418 and 420.

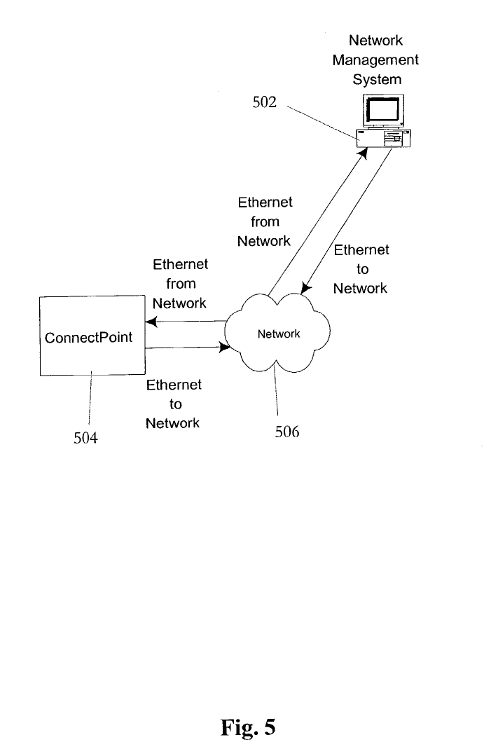

As illustrated in FIG. 5, an alternative embodiment of the optical communications system of the present invention may also be coupled to a network management system 502. In this embodiment, a connect point 504, provides information to, and receives information from, the network management system 502 when connected through a network 506. The information that can be provided to the network management system 502 includes standard network equipment Managed Information Base (“MIB”) information, via Simple Network Management Protocol (“SNMP”), as well as information specific to the system of the present invention. Such information may include, but is not limited to, statistics on beam acquisition and tracking behavior, and operational state and control information. The network management system 502 may control standard network equipment MIB settings, via SNMP, as well as some settings specific to the system of the present invention. These settings include, without limitation, assignment of a partner unit and characteristics of the beam acquisition and tracking behavior.

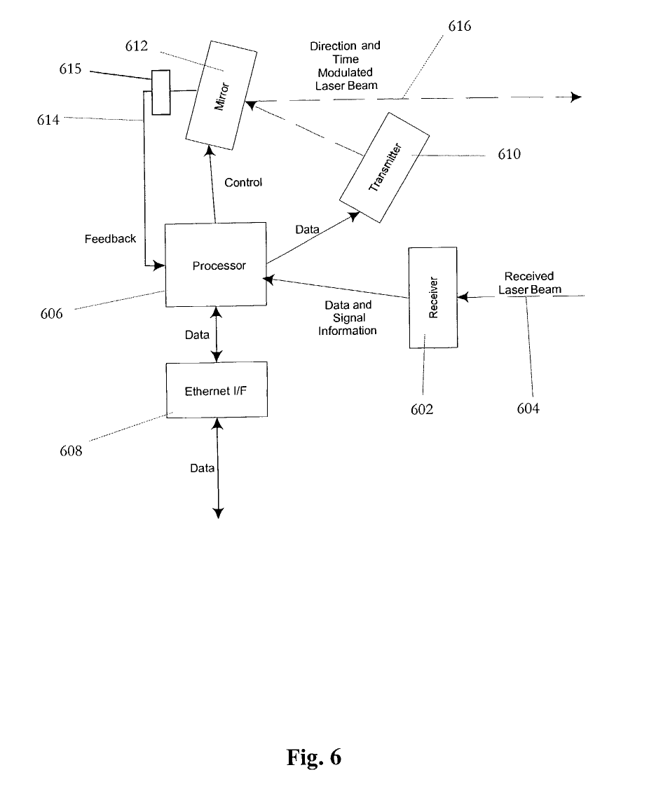

Referring now to FIG. 6, there is illustrated a diagram of the components of a connect unit. For illustrative purposes, the connect unit A 404 of FIG. 4 will be discussed. An optical receiver 602 configured to receive an optical signal, such as communication link 604, converts the optical energy from communication link 604 into electrical signals and sends the electrical signals to a processor 606. The processor 606 forwards data in the electrical signals to the network via an Ethernet interface 608. Similarly, information received from the network is received by the Ethernet interface 608 and sent to the processor 606. The processor 606 sends the data it receives in the form of electrical signals to a transmitter 610, which converts the electrical signals to optical signals that are transmitted via the transmitter 610. In this embodiment, the transmitter 610 directs the optical signal to a small electrically positionable mirror 612. The mirror 612 is positioned such that the optical signal is reflected via the mirror 612. The mirror 612 can be selectively positioned to aim the optical signal to another connect unit, such as the connect unit 410 (FIG. 4).

In this embodiment of the optical communications system of the present invention, the position of the mirror 612 is preferably controlled by the processor 606. Additionally, there is a feedback mechanism 614 between the mirror 612 and the processor 606 to provide information on the position of the mirror. This information may be used to more precisely positioning the mirror 612, if warranted. Due to mechanical characteristics of the mirror 612, it may be prone to vibration and may experience a damping action similar to a settling spring. The feedback mechanism 614 also assists in addressing this issue.

Since the mirror 612 is sensitive to impulses and externally induced motions, it can move slightly in response to external forces. Use of a mirror position detection mechanism 615 allows the processor 606 to detect and isolate these externally induced motions. The processor 606 is capable of compensating for the externally induced motions by applying opposite forces to the mirror, thereby canceling the effects of the external motion on the position of the beam 616 relative to the detector of the receiving unit. An alternate embodiment monitors the measurements via feedback mechanism 614 for externally induced motions of the mirror 612 to estimate accelerations applied to the housing of the connect unit due to vibration or low frequency motion of the physical mount. Processor 606 can use the information produced to stabilize the laser beam against base motion disturbances.

Control information may be sent between connect units via control packets using ‘in-band’ or ‘out-of-band’ signaling techniques. For purposes of this application, ‘in-band’ is used to mean embedding the control packets within the signaling bandwidth of the information data stream. In an embodiment of the optical communications system of the present invention, use of an in-band technique requires injecting the control packets into the Ethernet data stream in the same manner as all user packets. The term ‘out-of-band’ is used in this application to denote the use of a portion of the signaling spectrum that is out of the normal information bandwidth. In an embodiment of the optical communications system of the present invention, use of an out-of-band technique includes the use of packets modulated onto a sub-carrier of the primary Ethernet signal. The out-of-band approach is preferred since it does not reduce the available bandwidth for the Ethernet packets, and it provides a higher data rate and more dedicated path to enhance the ability of the units to stabilize against base motion of either unit.

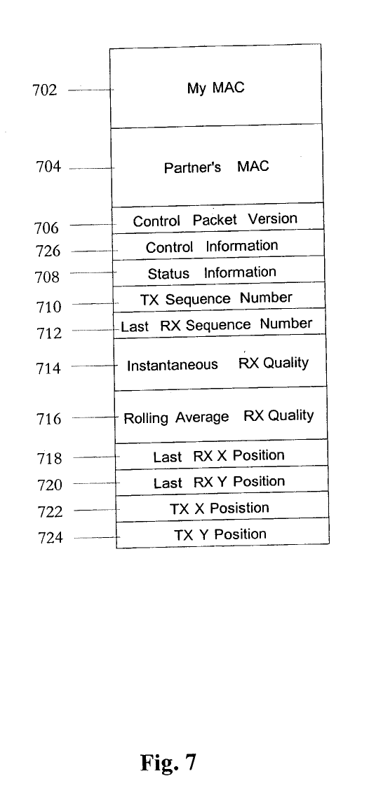

The structure of one exemplary control packet is shown in FIG. 7. In this embodiment of the optical communications system of the present invention, representative data fields comprise an identification of the transmitter 702, an the identification of the intended recipient 704, control packet version 706, status information 708, sequence number information 710, last RX sequence number 712, received quality measurements, such as instantaneous RX quality information 714, rolling average instantaneous RX quality 716, transmit x position, 718 and 720, and received mirror position information, such as TX X position 722 and TX Y position 724. The control packet version 726 is also preferably included. Control packet version compatibility is verified on each received packet. Other embodiments of the control packet may rely on the underlying transport to provide identification of senders and receivers, thereby reducing the amount of information required for each control packet. Yet additional embodiments may also include additional information on control packet error counts or information related to the performance of lower transport layers (e.g., PHY symbol error counts).

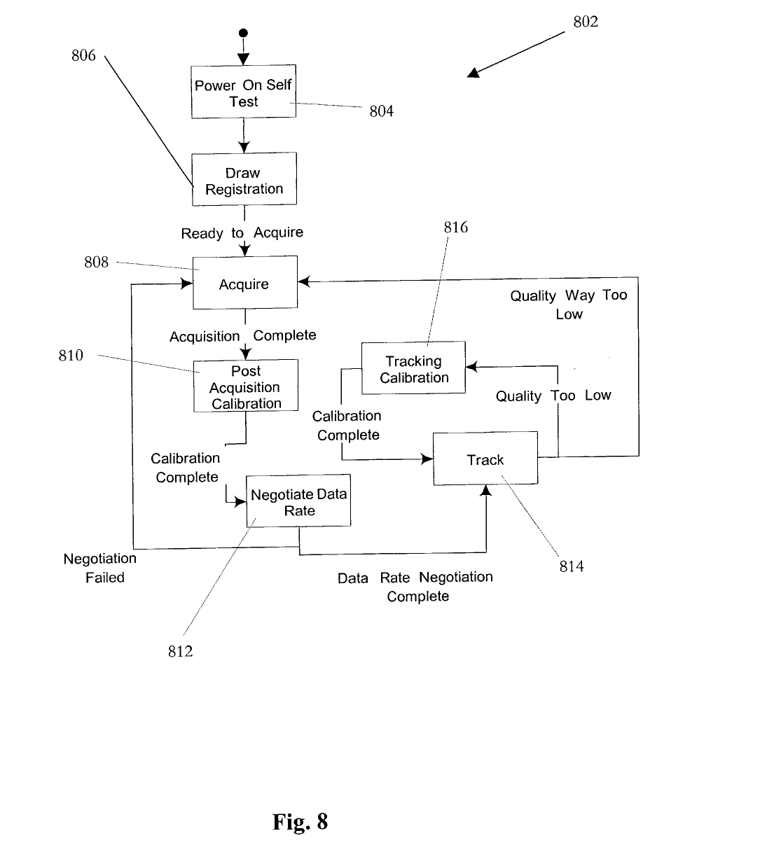

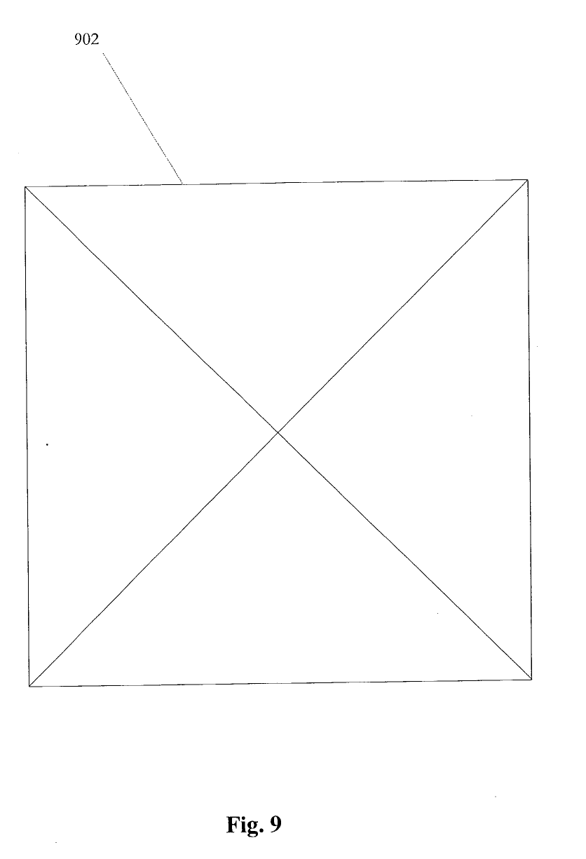

Now referring to FIG. 8, a flow diagram of a process 802 used by one embodiment of the optical communications system of the present invention is shown. According to the process, when a connect unit is powered on it performs certain self-diagnostic tests in step 804. In step 806, the laser and mirror draw a registration pattern (see FIGS. 9 & 10A). The registration pattern is used as a positioning aid and, when viewed, shows the available scanning area where a similar connect unit can be placed. An exemplary registration pattern 902 is shown in FIG. 9. The registration pattern 902 can be used as a positioning aid with visible lasers or with employing a device that allows the beams to be viewed. The registration pattern 902 also aids with freedom of movement of the mirror. The registration pattern 902 is traced to the extremities of the steering angles the mirror is capable of rotating in a rapid fashion.

Referring again to FIG. 8, in step 808 the process 802 “locates” another connect unit with which to establish a communications link. Once a link has been established, a calibration may be performed in step 810 to determine the performance center of the detector of the opposite connect unit. Prior art systems assume both the detector and the laser beam are uniform in shape, and attempt to center the beam spatially on the detector. The optical communications system of the present invention is not limited by such assumptions. The present invention system and method maintains a distinction of a performance center and specifically attempts to position its transmit beam at the point where the optical and environmental characteristics allow the best link quality, a point not necessarily co-located with the optical center of the beam. After the calibration step 810, the data rate is then negotiated in step 812. A tracking routine 814 is subsequently commenced. The tracking routine 814 monitors the signal quality so that the communications link established in step 808 may be maintained. For example, when the signal quality drops below a predetermined set gate, a recalibration or reacquisition step 816 is invoked. The re-calibration or reacquisition step 816 utilizes the same process(es), including, without limitation, the same algorithm(s), as utilized in the original acquisition step 808 to continually optimize the performance centering of the beam on the detector.

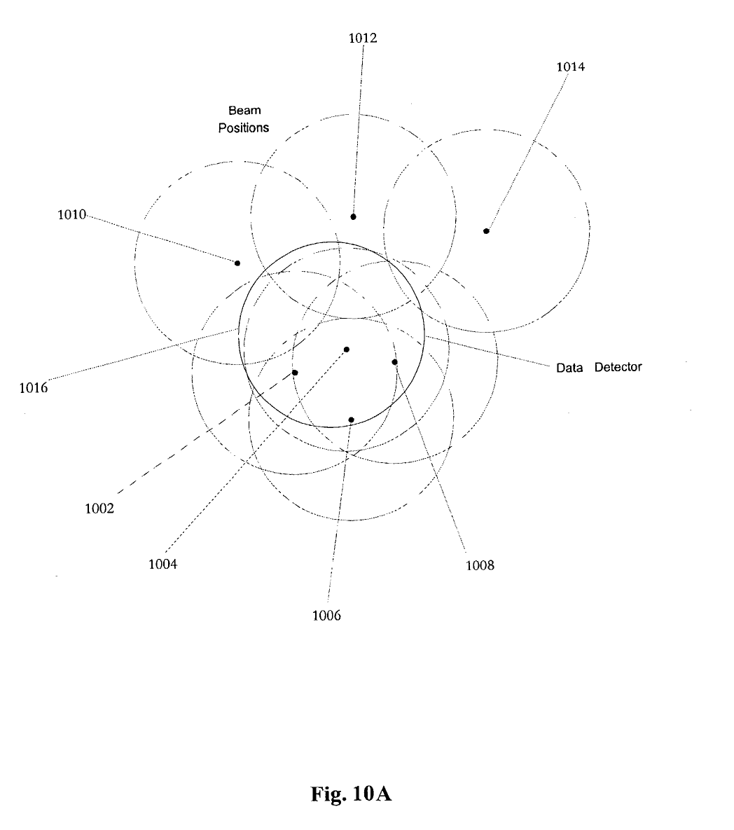

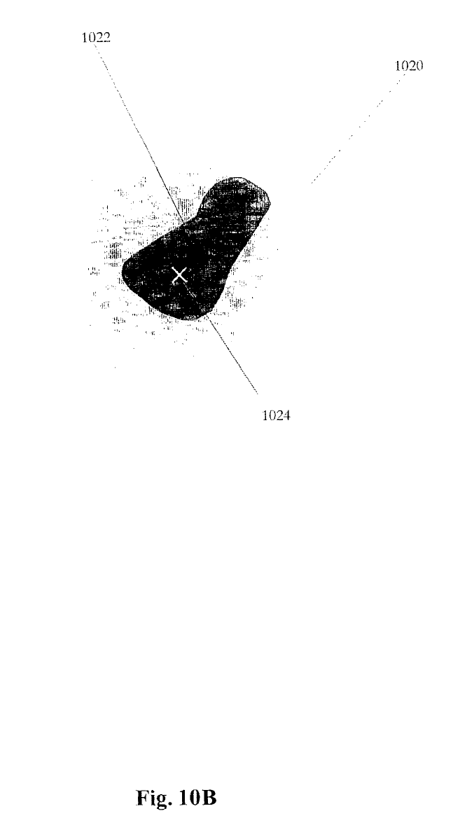

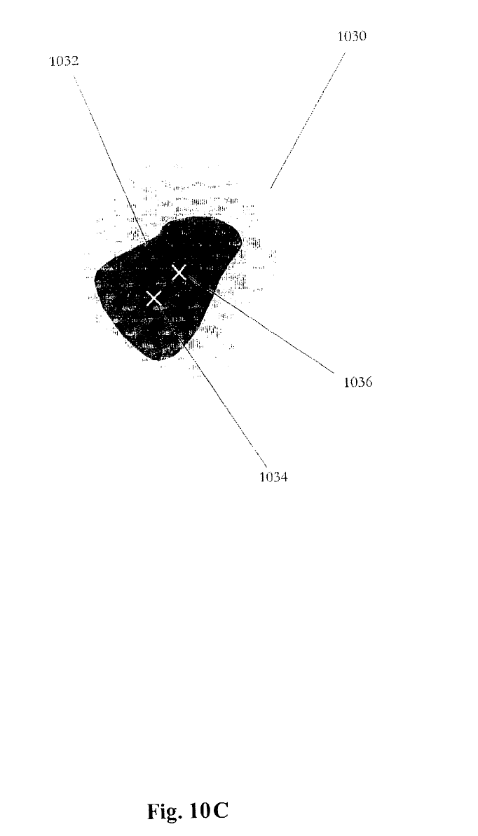

Turning back now to FIG. 7, when sending control packet information to another connect unit (FIG. 4) each connect unit may include its current mirror position 722 and 724, the last seen mirror position reported from the opposite unit 718 and 720, and the instantaneous receive quality 714, and rolling average quality measurement 716 for that position. This information is used to maintain a running weighted average estimate of the center of the detector of the opposite connection unit. For instance, if the “seen” positions were as shown as in FIG. 10, the positions 1002, 1004, 1006, and 1008 would have higher quality measurements associated with them than those indicated by positions 1010, 1012, and 1014. This position information would affect the weighted average by moving the weighted average towards the values of positions 1002, 1004, 1006, and 1008, and, consequently, closer to the actual center of the detector 1016. The use of a weighted average based on quality measurements speeds up the acquisition step of the method and provides an accurate estimation of the position of detector of the opposite connect unit. An alternate embodiment employs a relatively simplified approach of maintaining the weight on the center calculation by directly adding to or subtracting from the estimate the weight for each occurrence of new position information or on quality or distance information from current center measurements. In the optical communication system and method of the present invention, the calculations regarding the location of the detector center are performed on the connect unit including that detector (i.e., locally), as opposed to remote performance (i.e., calculations are performed at the opposite connect unit) of such calculations by prior art systems and methods. By calculating the performance center locally, manual adjustments to the calculations and the results are more easily performed. These may be performed when certain conditions occur, such as some operational state changes and/or during acquisition steps.

Receive-based quality measurements are made and averaged over a time period. The time period varies with the operational state of the optical communications system and method of the present invention. Measurement of received-based quality is made by determination of the amount of control information received in a set time period as compared with the predicted amount of such information and/or with direct measurement of the received laser signal quality. Alternate embodiments use measurements obtained directly from the link at layers below the control packets to accomplish these measurements. For example, symbol errors counted on a PHY (physical interface) device can be factored into the quality measurement. When received from the opposite unit, the quality measurement and last seen position are added to a running calculation of the position of the center of the detector of the opposite connect unit. The location of the position is weighted by the quality measurement when added to the average. The average is performed over a set number of samples that occur at regular time intervals. If information is not received from the opposite unit during a sample, an older measurement may be removed from the average such that after an extended time period with no received new information the average will be zero. Older measurements may be replaced by newer measurements of higher quality. When an older measurement is not replaced by a newer measurement of lower quality, the weight in the average is reduced such that after several occurrences of older information not being replaced, the measurement will be reduced to a quality level of zero and removed from the list. This behavior precludes degradation of the calculated center by inaccurate measurements over an extended period of time. An alternate embodiment uses a relatively simplified approach to this feature by adding to or subtracting from the weighted average based on available quality measurements or by use of alternate techniques of maintaining an evaluation of the quality measurements over time.

By calculating location of the performance center locally, manual adjustments to the calculations and the results may be more easily performed. Such manual adjustments may be performed when certain conditions occur, such as operational state changes and/or during acquisition steps.

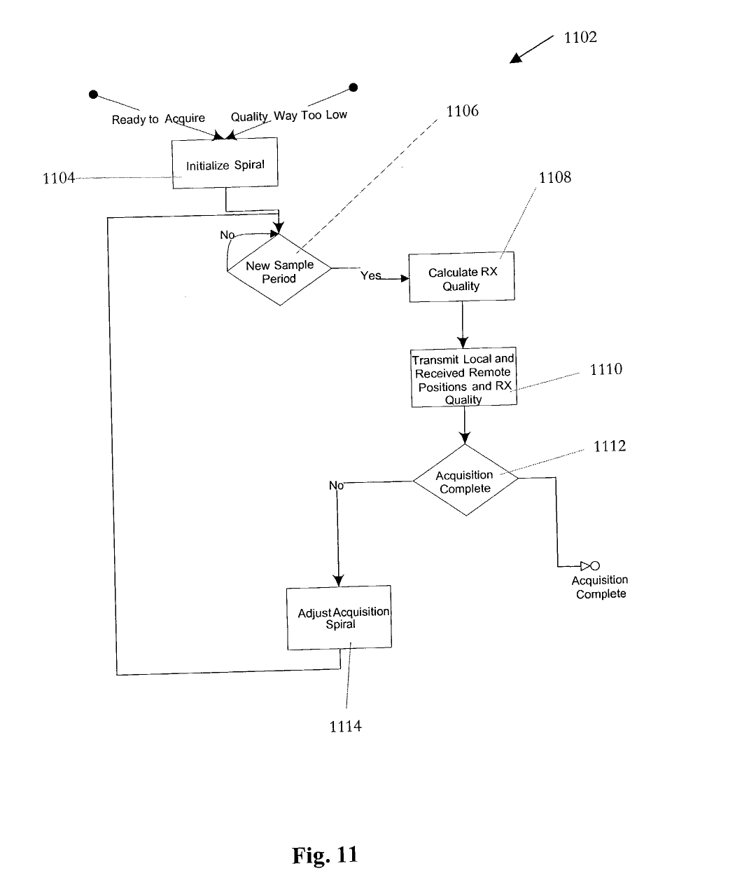

Turning now to FIG. 11, there is illustrated a sub-process 1102 of step 808 of the optical communications method of the present invention. The sub-process 1102 allows the connect unit to acquire a signal from an opposite connect unit. In step 1104, the characteristics of a spiral pattern are first initialized. Associated with step 1102 is the sub-step of initiating a sample period. In step 1106, a determination is made as to whether a new sample period has been initiated. If a new sample period has been initiated, the receive quality is calculated in step 1108. While the unit is transmitting in a spiral pattern, it is also transmitting quality and position information (step 1110), such as receive remote positions and receive quality information. At this stage of the subprocess 1102, the larger process 802 proceeds to step 810 (FIG. 8). The foregoing steps are repeated once for each sample period until the acquisition gates are met (step 1112). Adjustments to the spiral are made in step 1114, and measurement and calculation of quality values, step 1108, are performed periodically as controlled by decision 1106. These steps allow adjustments to the spiral pattern to be made periodically in step 1114, until the acquisition step 810 is complete. The decision to complete acquisition is based primarily on the rolling average quality measurements made by both connect units. When both connect units achieve quality measurements above a predetermined level, acquisition is considered complete.

The primary goal of the acquisition process, as well as the post acquisition centering processes, is to find the optimum position for the beam relative to the location of the detector of the opposite connect unit. Turning to FIG. 10B, the optimum position 1024 is considered to be the location of the center of the largest region 1022 within the beam 1020 that provides the maximum link quality. Centering a beam within this region is critical for providing the maximum tolerance to disturbance of the beam due to environmental factors. If a beam can be assumed uniform in shape, an optical centering technique can provide the optimal position. Turning to FIG. 10C, it is demonstrated that such an assumption (i.e., that a beam is considered uniform in shape) can produce problems for optical communication systems. An apparently uniform beam 1030 may have a non-uniform maximum data region 1032. In such a case, the location of the optical center 1036 of the beam 1030 does not coincide with the location of the center 1034 of the beam. Prior art optical communication systems consider the acquisition process complete when the beam was located over the detector. Such a determination would lack the optimization and any post acquisition optimization provided by the optical communications system and method of the present invention. Lack of such features in this example would result in a sub-optimum positioning of the beam, likely rendering the communications link incapable of supporting full data rates and more susceptible to disruption due to environmental factors.

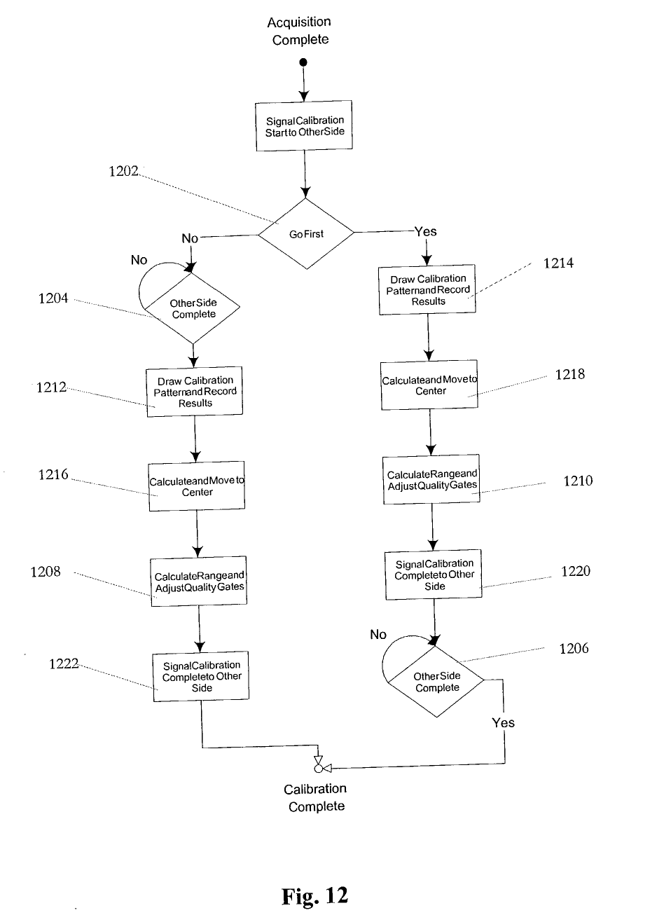

After the acquisition sub-process 1102 is completed, an embodiment of the optical communications method of the present invention includes a process for producing a more precise determination of the location of the performance center of the detector of the opposite connect unit. Turning to FIG. 12, which is an elaboration of step 810 of FIG. 8, this process is illustrated in a flow chart. In this embodiment, two connect units coordinate the ordering of the calibration in steps 1202, 1204, and 1206. The connect units may perform calibration one at a time so that measurements can be transmitted from the connect unit not currently calibrating. An estimate of the range is made during this process in steps 1208 and 1210 by comparing the data received while the calibration patterns are drawn against the known spatial characteristics of the beam and the detector. The calibration process follows the same steps on each connect unit. In step 1202, there is a determination made as to which connect unit will conduct calibration first. This determination may be performed utilizing a handshake protocol using unique identifiers on each connect unit. Such a determination step can also be accomplished using a collision detection and random back off scheme approach. After the initial determination step 1202, a calibration pattern is drawn by the first connect unit and measurements are recorded in steps 1212 and 1214. These measurements are used to make a calculation of the location of the center of the detector of the opposite connect unit in steps 1216 and 1218. The beam may then be moved to the calculated position. A calculation of a range is made in steps 1208 and 1210, which may involve drawing a second calibration pattern and collecting additional measurements. If warranted, the quality gates for subsequent behavior are modified to match the determined range. A handshake at the end of the calibration in steps 1220, 1222, and 1206, completes the synchronization of the connect units.

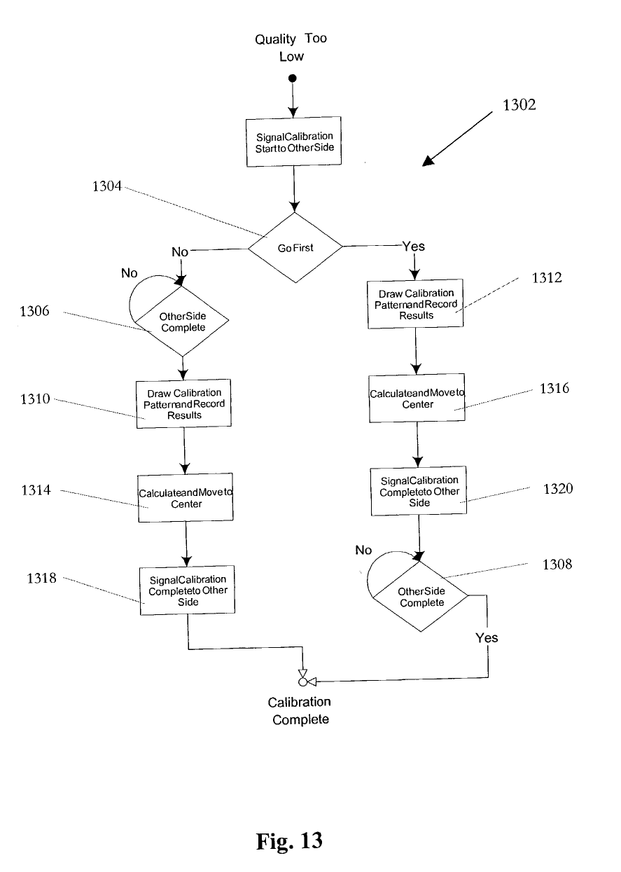

As discussed in reference to steps 816 and 814 of FIG. 8, after the initialization phase, the beams of the two connect units may drift. Thus, the process 802 also tracks the signals and if the measured quality dips below a predetermined gate, a calibration process is performed to re-center the beam in detector of the opposite connect unit. This process is illustrated in FIG. 13, which is an elaboration of step 816 of FIG. 8. In this embodiment of the optical communications system and method of the present invention, the two connect units coordinate the ordering of the calibration in steps 1304, 1306, and 1308. They may perform calibration one connect unit at a time so that measurements can be transmitted from the connect unit not currently undergoing calibration. The calibration process follows the same steps on each connect unit. In step 1304, there is a determination of which unit will undergo calibration first. This determination is preferably performed with a handshake protocol using unique identifiers on each connect unit in conjunction with a collision detection and random back off scheme approach. Such determination may also be made to assist with the tracking calibration to be performed on only one connect unit. After the initial coordination on which connect unit will be calibrated first, the calibration pattern is drawn and measurements are recorded in steps 1310 and 1312. These measurements are used to make a calculation of the location of the center of the detector of the opposite connect unit in steps 1314 and 1316, and the beam is moved to the calculated position. A handshake at the end of the calibration in steps 1318, 1320, 1308, completes the synchronization of the connect units.

The post acquisition calibration and tracking calibration processes are similar, but have at least two differences in the illustrative embodiments. The first difference is that the tracking calibration process does not perform a range calculation and an adjustment of the quality threshold gates. The second difference is that while the primary goal of the processes is both to position the beam, the secondary goals are different. A secondary goal of the tracking calibration process is to minimize data loss across the communications link. As a result, the tracking calibration is undertaken while the link is active. The post acquisition calibration process, however, is accomplished while the link is inactive and is intended to find the location of the center of the detector of the opposite connect unit regardless of beam aberration or diffraction artifacts, such as halos. These different secondary goals of the two calibration processes are addressed by using different calibration patterns drawn by the laser with a mirror, recognizing that different configurations may be better suited for different functions. For example, a crossbar pattern may be well suited to a post acquisition calibration process when a uniform circular beam shape can be assumed. On the other hand, a spiral pattern or a matrix pattern can be used when beam shape uniformity cannot be assumed. Selection of a pattern also may be based on the mechanics of the positioning mechanism(s) of the mirror. With some mirrors, a spiral pattern may provide smoother and more accurate movement. On the other hand, a crosshair pattern drawn just slightly larger than the detector of the opposite connect unit may be better suited for the tracking calibration process. Such configuration patterns will be discussed in further detail below.

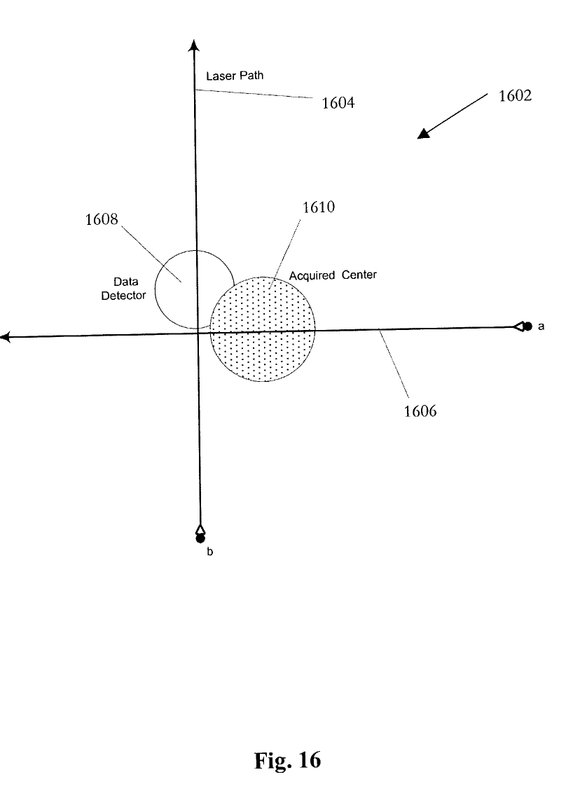

Turning now to FIG. 16, there is shown an exemplary pattern 1602 of beam movement that may be used for calibration. The pattern 1602 draws two lines 1604 and 1606, respectively. In the example, the line 1606 is substantially horizontal and the line 1604 is substantially vertical. The pattern 1602 may allow the connect units to determine the center of the data detector 1608. This illustrative pattern may be well suited to the location of center determination portion of the post acquisition calibration process as discussed in reference to steps 1216 and 1218 of FIG. 12. The pattern 1602 also may be used for beam size determination. The first line drawn, 1606, will be through a center 1610 as determined by the acquisition process. The second line 1604 will be through the center determined by the measurements taken when drawing the first line 1606.

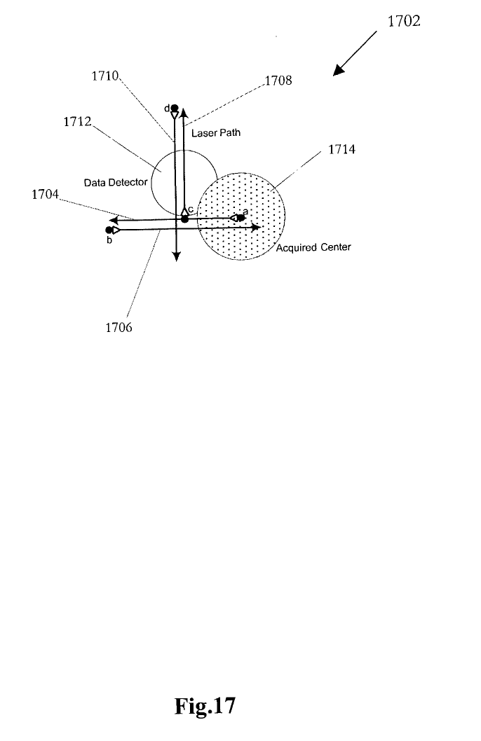

In FIG. 17, there is shown a pattern 1702 of beam movement that also may be used for calibration processes. The pattern 1702 employs four lines. In this example, lines 1704 and 1706 are substantially horizontal and lines 1708 and 1710 are substantially vertical. The pattern 1702 may assist in the determination of a detector 1712, as well as the size of the beam 1714 relative to the detector 1712 of the connect unit. The pattern 1702 is intended to determine the location of center and beam size with the least disruption to an operational link and may be suited to the center determination portion of the tracking calibration process as discussed in reference to steps 1312 and 1314 of FIG. 13. The first line 1704 and second line 1706 may be drawn through the center of an area 1714 where location of the detector 1712 was determined during the acquisition. The third line 1708 and fourth line 1710 employed may be drawn through the center of the detector 1712 determined by the measurements taken when drawing the lines 1704 and 1706.

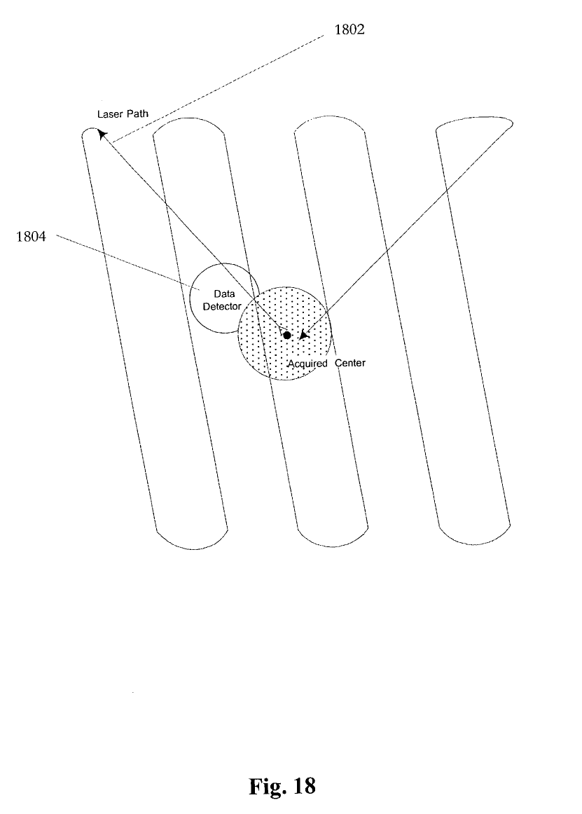

FIG. 18 shows an alternative pattern of beam movement that may be used for calibration. The pattern draws a grid 1802, across an area around and encompassing the detector of the opposite connect unit 1804. Such a matrix calibration can be used to determine beam shape and halos, which may be used to evaluate running analog measurements. This type of pattern is suited to calibration use when the beam shape cannot be assumed to be circular. This pattern also has the best ability to determine the location of the optimum performance center for beam positioning when beam shapes are non-uniform.

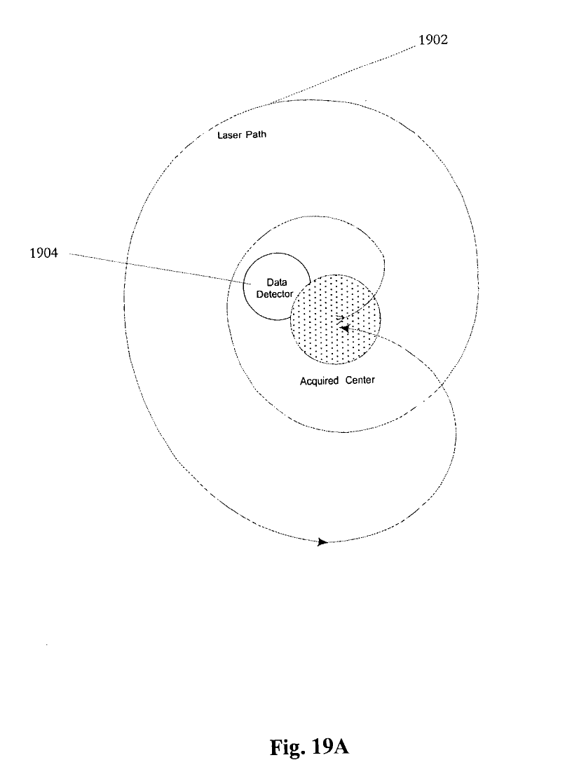

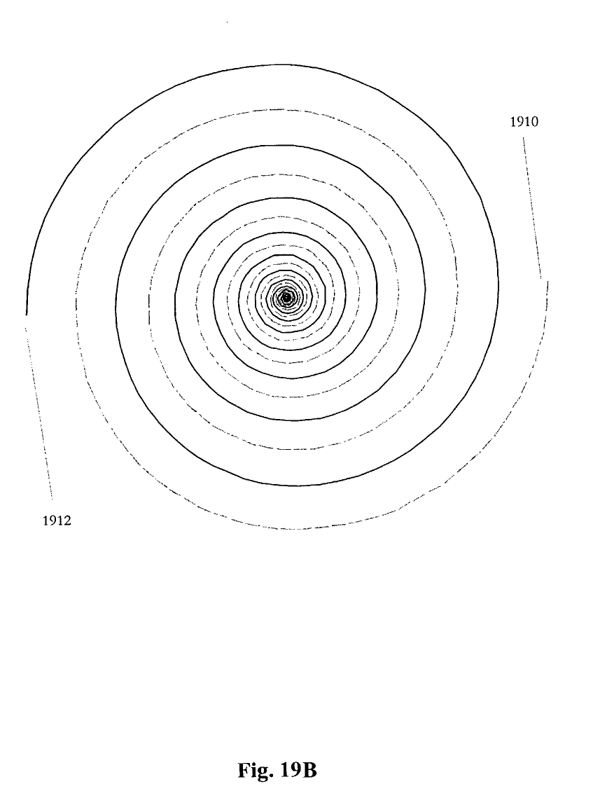

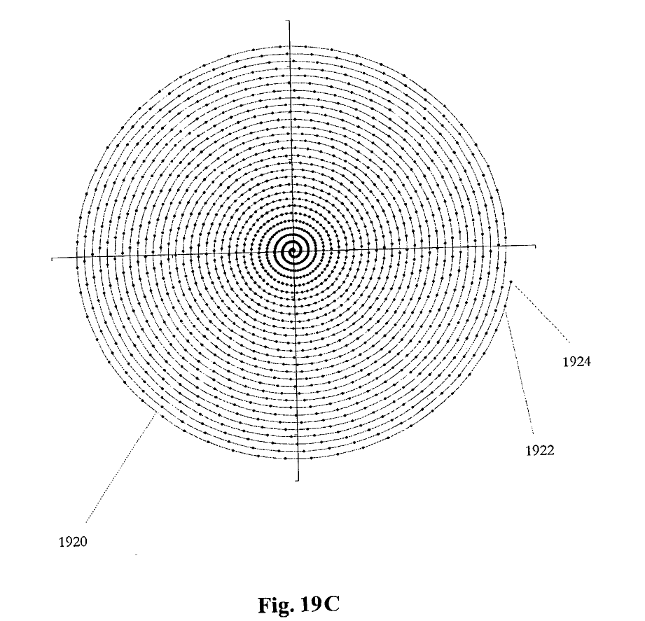

FIG. 19 shows an alternative pattern 1902 of beam movement that can be used for calibration. The pattern 1902 draws a spiral across an area around and encompassing the detector 1904 of the opposite connect unit. This type of pattern can be used to determine beam shape and halos, which can be used to evaluate running analog measurements. The pattern 1902 is suited to calibration use when the beam shape cannot be assumed to be circular. The spiral pattern 1902 can be used to accomplish the same tasks as the matrix pattern 1802 (FIG. 18), but may be better suited to the specific mechanics of a certain mirror.

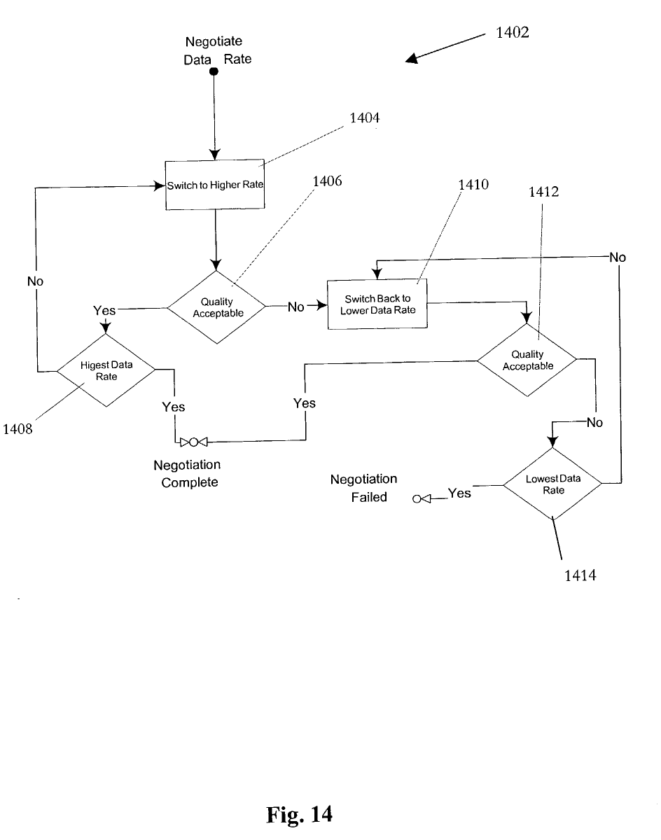

Turning back to FIG. 8, after the calibration has been completed between two connect units, the data rate may be negotiated and determined in step 812. FIG. 14 shows one example of a negotiation process 1402 that may be used in connection with an embodiment of the optical communication method and system of the present invention. Acquisition is performed at the lowest available data rate to provide the greatest range for the optical link established. When acquisition is completed and the beam has been centered on the detector of the opposite connect unit, the connect units will move up to the highest data rate that they can maintain with acceptable quality. This is accomplished by progressively switching to the next higher data rate as in step 1404, and then, at each switch, determining whether the quality of the link is acceptable in step 1406. If the quality of the data rate is acceptable, in step 1408 a determination is made whether the current rate is the highest data rate available. If so, the negotiation will be considered complete. If the quality is not considered acceptable by step 1406, the data rate may be dropped back to the previous rate in step 1410. In step 1412, the quality will be reassessed and the acquisition will be considered complete, if that level of quality is determined to be acceptable. If the quality is determined to be unacceptable, the data rate will be progressively backed off in step 1414, until a suitable rate is achieved. If an acceptable quality can not be established at any rate, the negotiation will fail, which will trigger a reacquisition process, such as described in reference to step 808 of FIG. 8.

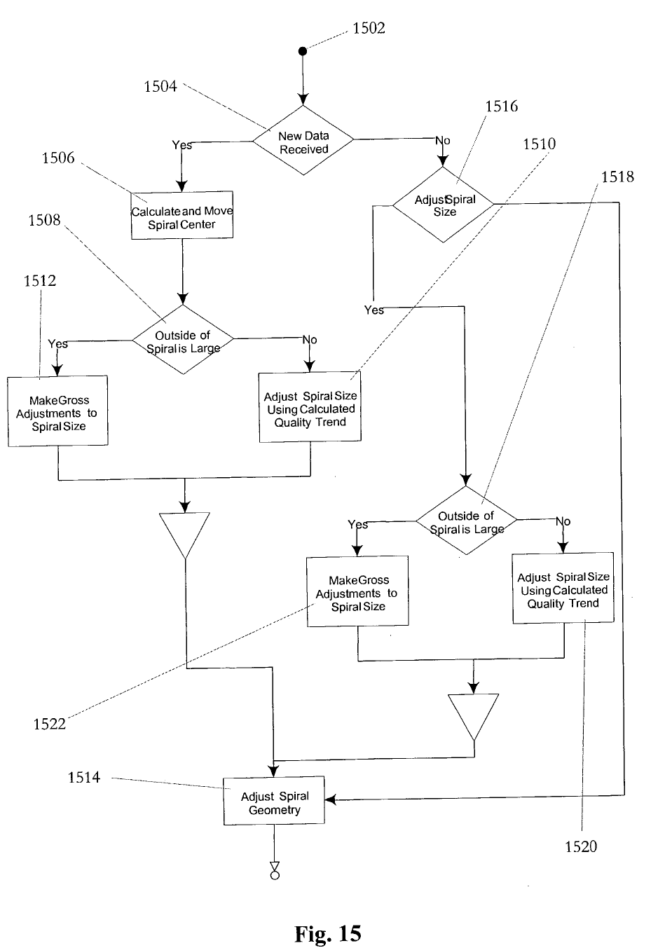

In one embodiment, a spiral pattern, such as spiral pattern 1902 of FIG. 19A, may be used for search and acquisition. The size, position, and geometry of the spiral are altered dynamically to efficiently acquire the opposite connect unit. Such a process is shown in FIG. 15 via a flow diagram. Quality measurements, reported positions, center calculations, and historical information are all used to calculate the various aspects of the spiral pattern. In general, the goal of the spiral control process is to shrink the spiral to a very small size centered over the detector of the opposite connect unit. The radial spacing of the spiral is also controlled dynamically to reduce the average time that it takes to cross detector of the opposite connect unit. Turning now to FIG. 19B, an example of a spiral pattern is shown. The first spiral 1910 drawn by the connect unit is spaced (radially) by a greater amount than would be used for a single pass with complete coverage. The second pass 1912 has a different initial angle so that it fills in the gaps of the spiral 1910. This technique allows optimization of the efficiency with which the spiral 1910 is radial spaced while precluding gaps in the area covered. Turning to FIG. 19C, a second related technique is illustrated. In addition to optimization of radial spacing, the spacing of the transmission of data relative to the angle on any given spiral rotation is also critical for providing complete coverage efficiently. In this case data transmissions occur at the positions indicated in FIG. 19C by the points, such as points 1922 and 1924. The path 1920 through which the beam is moved is shown. By careful choice of the frequency of the spiral drawn, the transmit spacing relative to angle can be forced to change in a known pattern from one rotation of the spiral to the next providing the most efficient data spacing for achieving complete coverage of the area to be drawn.

Turning back to FIG. 15, the spiral control process is triggered in step 1502, on a regular, periodic, basis while acquisition is being performed, for instance in step 808 of FIG. 8. All spiral geometry changes are calculated from the running quality measurements or derivatives or integrals thereof. In step 1504, a determination is made as to whether new control information has been received from an opposite connect unit. If new information has been received, the center of the detector of the opposite connect unit is calculated using the new information and the spiral center is moved smoothly to the new position as the spiral is being drawn in step 1506. In step 1508, a decision is made based on the size of the outer edge of the spiral. If it is below a predetermined size, in step 1510 the spiral size is adjusted using a running calculated trend of the remote quality. The adjustment at this point serves to shrink the spiral. If step 1508 determines that the outer edge of the spiral was above a predetermined size, a gross adjustment is made to reduce the spiral size in step 1512. The adjustment at this point serves to rapidly shrink the spiral. Additional adjustments may also be made to the spiral geometry in step 1514, based on quality measurement trends and the current spiral size. An alternate embodiment of this process is to alter the spiral geometry based solely on the quality measurements without the use of the accompanying logic. In this embodiment, the spiral size is increased or decreased based on the quality measurements. The minimum radius of the spiral is also adjusted during this process and becomes the key factor in determining the link quality (not considering post acquisition centering) when the acquisition is completed. By adjusting the minimum radius of the spiral such that it is maximized while the quality measurements indicate that the maximum data rate is available, a reasonable estimate of the location of the optimum performance center of the beam can be obtained. If the beam maximum data rate region does not contain severe multiple peaks, this technique can effectively find the location of the optimum performance center without the use of post acquisition centering techniques.

Referring again to step 1504, if no new data was received when the spiral control process is triggered, the process proceeds to step 1516. In step 1516, a determination is made to adjust the spiral size based on the time since the last control information was received and on calculated quality trends as to whether to adjust the spiral size. If it is determined that the spiral size should be adjusted, then the process proceeds to step 1518, where a further determination is made based on the size of the outer edge of the spiral. If the size of the outer edge is below a predetermined size, the spiral size is adjusted using a running calculated trend of the remote quality in step 1520. The adjustment at step 1520 serves to increase the size of the spiral. If it was determined that the outer edge of the spiral was above a predetermined size, a gross adjustment is made to increase the spiral size in step 1522. The adjustment at this step 1522 serves to rapidly increase the size of the spiral. In step 1514, additional adjustments are made to the spiral geometry based on quality measurement trends and the current spiral size.

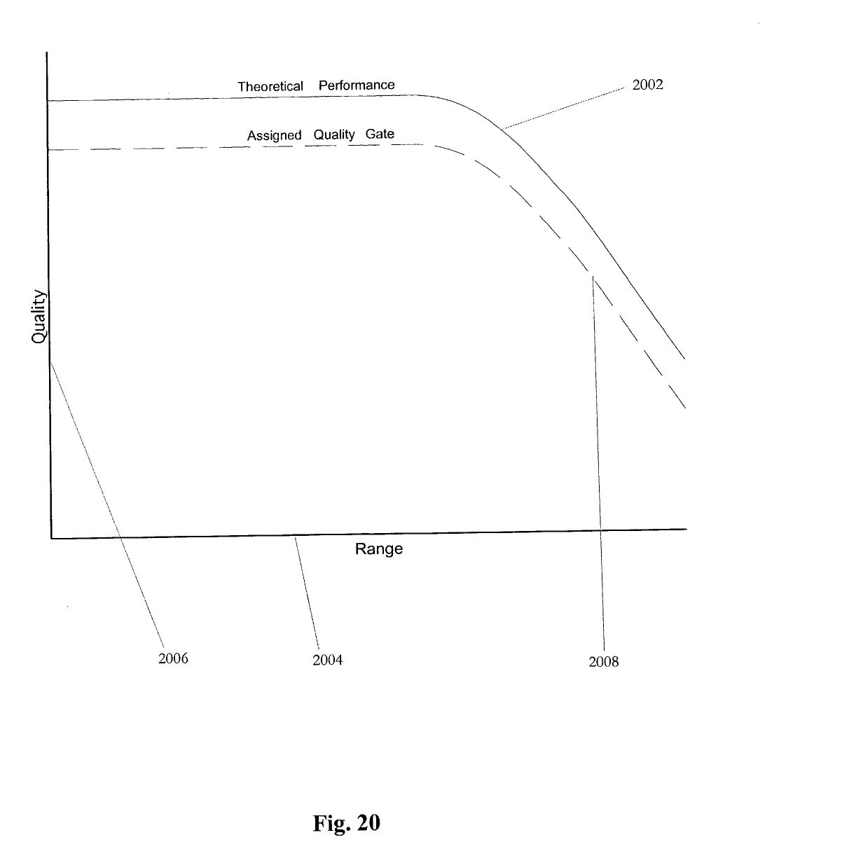

FIG. 20 shows a graph 2002 illustrating the relationship between the distance between the connect units, or range 2004 (x-axis) and signal quality 2006 (y-axis). As can be seen as range 2004 increases between two connect units past a certain point, the quality 2006 of the signal decreases. One embodiment of the optical communication system and method of the present invention uses quality gates as determination criteria. It is sometimes desirable that embodiments be allowed to operate at greater range even if the quality is degraded. A set of quality gates indexed by range as indicated by plot 2008, may be used for this purpose. The quality gates may be selected by the range calculation performed during post acquisition calibration, as performed in steps 1208 and 1210 of FIG. 12.

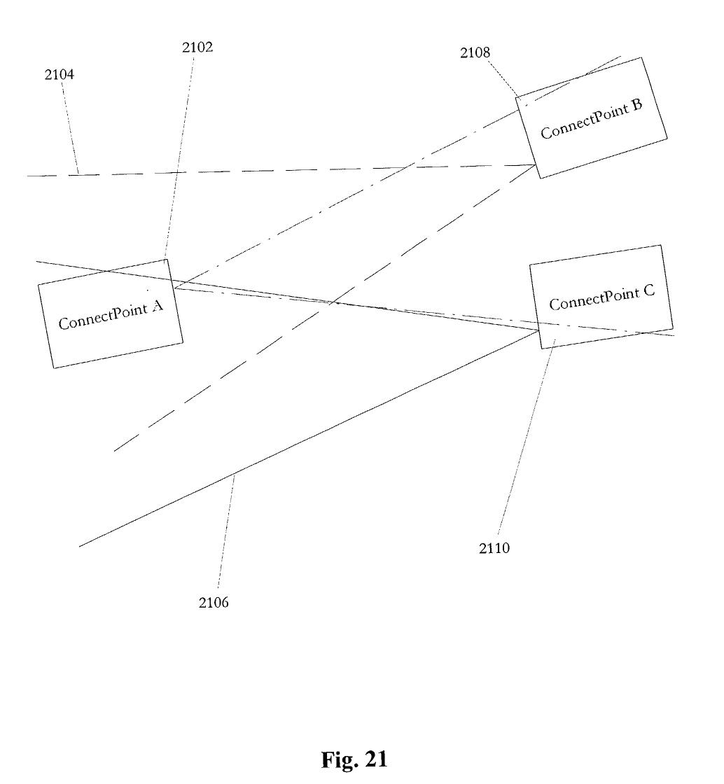

FIG. 21 depicts an exemplary installation of an embodiment of the optical communications system and method of the present invention where connect unit 2102 is within the fields of view 2104 and 2106 of two other connect units 2108 and 2110. Since connect unit 2102 can receive control information from both connect units 2108 and 2110, it may be necessary for connect unit 2102 to discriminate between the two connect units 2108 and 2110. Prior art systems and method propose to achieve this discrimination through spatial discrimination whereby no more that one connect unit is allowed within the field of regard of any other connect unit. If it is required that multiple connect units be within the field of regard of a connect unit, additional hardware (i.e., unique retro-reflectors and/or additional positions sensing elements) are required to perform discrimination. In contrast, the optical communications system of the present invention achieves this intra-field discrimination through signal processing and/or control information, precluding the need for added hardware or sensors.

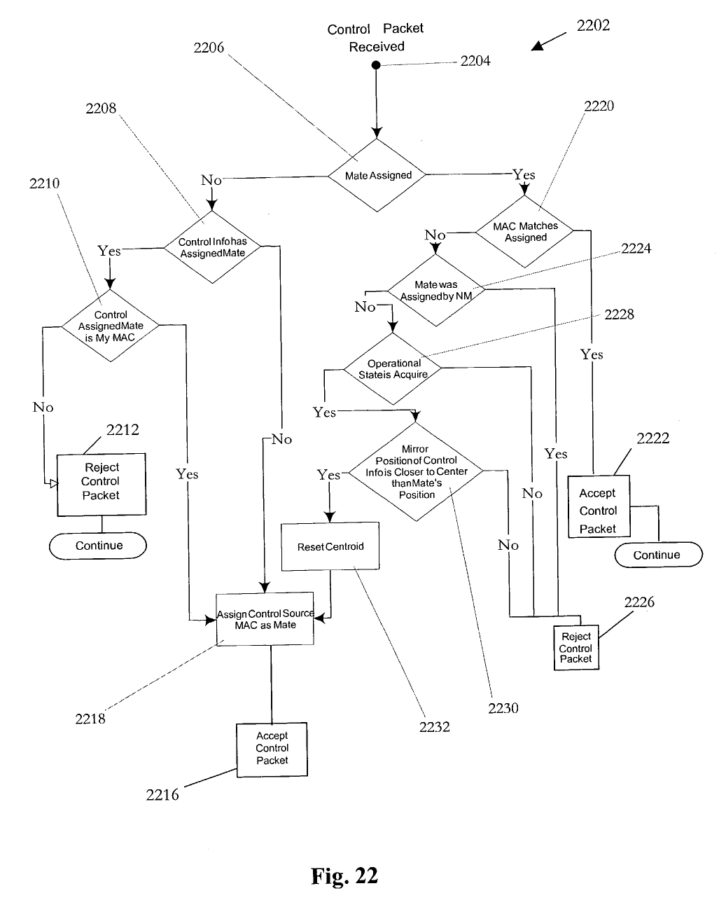

FIG. 22 illustrates a process 2202 for discrimination between connect units. In this embodiment of the optical communications system and method of the present invention, there are at least two mechanisms provided for assigning a mate connect unit. The Medium Access Control address (“MAC”) for a mate connect unit may be assigned directly via the network management interface (as discussed in reference to FIG. 5). If the MAC for a mate connect unit has not been directly assigned, the process 2202 will favor the connect unit that is pointed most directly at it. According to the process 2202, a control packet is first received in step 2204. In step 2206, it is determined whether a mate connect unit has been assigned, either explicitly or from previously received control packets. If a mate connect unit has not been assigned, in step 2208 control information is examined to determine if the other connect unit has an assigned mate. If the other connect unit has an assigned mate, in step 2210 the assigned address of the other connect unit is compared against its own address. If it does not match, the control packet is rejected in step 2212. If it does match, then the process proceeds to step 2216, where the MAC of the other connect unit is assigned as the mate, and the control packet is accepted in step 2216.

Turning back to step 2208, if a determination is made that the connect unit sending the control packet did not have a mate connect unit assigned, the process continues to step 2218 where the MAC of the other connect unit is assigned as the mate connect unit, and the control packet is accepted in step 2216.

Turning back to step 2202, if a determination is made that a mate connect unit has been assigned, the process proceeds to step 2220 where the assigned MAC is compared against the address of the connect unit that sent the control packet. If the assigned MAC matches, the control packet is accepted in step 2222. If the assigned MAC does not match, the process proceeds to step 2224, where a decision is made based on whether the MAC was assigned by a Network Management System. If it was assigned, then the process proceeds to step 2226 where the control packet is rejected. If the MAC was not assigned, then the process proceeds to step 2228 where the operational state is checked. If an acquisition is not being performed, the process proceeds to step 2226 where the control packet is rejected. If an acquisition is being performed, the process proceeds to step 2230 where the positional information of the control packet (e.g., items 722 and 724 of FIG. 7), is compared against the last seen position of the currently assigned mate connect unit. If the last seen position of the control packet is closer to zero, the process 2202 proceeds to step 2232 where the center calculation is reset. The process then proceeds to step 2218 where the MAC of the other connect unit is assigned as the mate connect unit and the control packet is accepted in step 2216. If the currently assigned position of the mate connect unit is not closer to zero, the control packet is rejected in step 2226 and the current mate connect unit is retained. A control packet also may be rejected if its MAC matches the devices assigned MAC, which indicates that the packet was reflected back to the sender.

In an alternative embodiment, a physical method for establishing preferred discrimination is also provided. This is accomplished via a switch on the device allowing selection of one number in a set of numbers. By selecting the same number on two connect units, such connect units would establish a discrimination preference for each other over any other connect units from which they may receive control information.

Another alterative embodiment provides discrimination between connect units even if the multiple connect units are within the instantaneous field of view. Application of well understood code division signal modulation allows the receiving unit to isolate and lock-on to only one of the connect units within the instantaneous field of view.

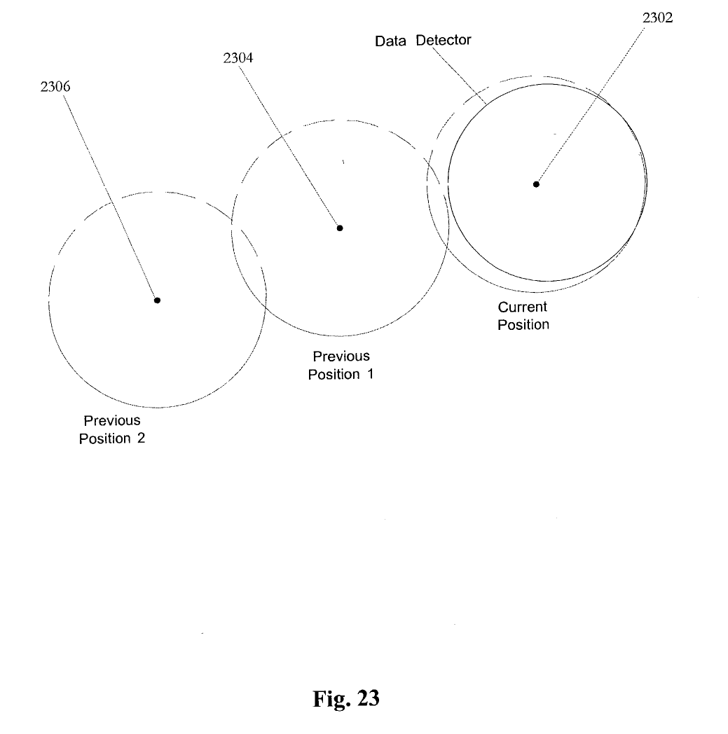

As previously discussed, positional drift or oscillation of a beam can be caused by mechanical or environmental factors. An example of positional drift is shown in FIG. 23. A position 2302 of a mirror has moved after a tracking calibration or after a reacquisition. By comparing previous positions, such as 2304 and 2306, with each other and the current position 2302, a positional drift can be determined. A positional drift can also be detected by comparing a series of measurements taken over several control packets. Regular, periodic movements can also be detected in this fashion. These movements may be addressed via the application of motion to the mirror to counteract the measured periodic movement.

When a positional drift is detected, a periodic motion may be applied to the mirror. This counteracting motion keeps the beam centered longer and minimizes the need for more severe corrective actions, such as calibration or reacquisition.

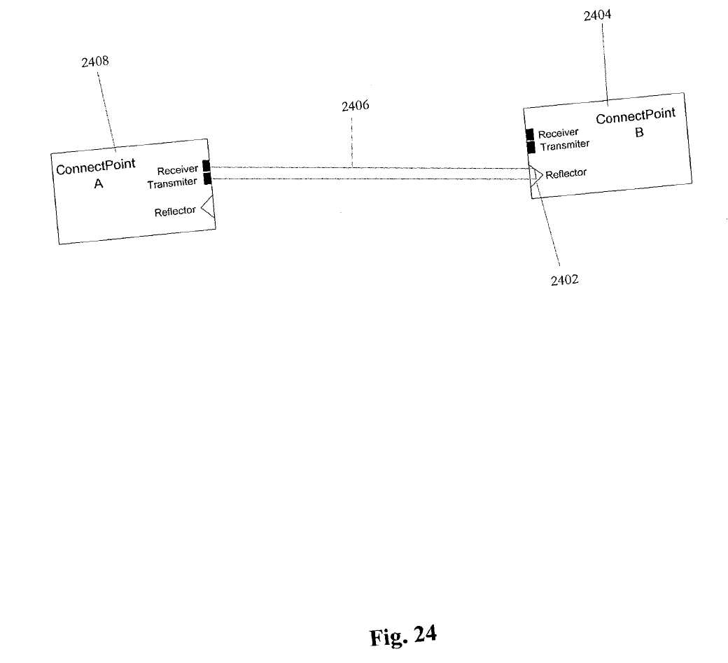

Referring now to FIG. 24, there is shown a corner reflector 2402 (also referred to as a retro-reflector) which optionally may be fitted to the front of a connect unit, such as connect unit 2404. The reflector 2402 will reflect a beam of light 2406,back towards its origin, which in this illustrative example is connect unit 2408. Depending on the size of the reflector 2402, there may be only a small displacement. Prior art optical communications systems and methods make use of retro-reflectors along with additional dedicated sensors to achieve discrimination. In contrast to such prior art, the optical communications system and method of the present invention uses the retro-reflective technique along with its existing detector to detect its own transmitted signal for assistance with pointing its transmitted beam. This reflection may be utilized by the connect unit 2408 as an initial pointing aid while mounting the connect unit, as well as an aid in more rapidly locating the detector of the connect unit 2404 during acquisition. While mounting the connect unit 2408, and pointing it at the opposite connect unit 2404, an audio and/or visual indication may be provided when a reflection is received. This indication informs the user that the opposite unit 2404 is within the field of view of the connect unit being mounted. Additionally, during the acquisition phase, the reflection can be used to re-center a spiral pattern and greatly reduce the area to be scanned to more rapidly converge on its opposite unit. Multiple retro-reflectors may also be employed so that the invention may make a direct estimate of the opposite unit's detector and directly position with or without additional scanning.

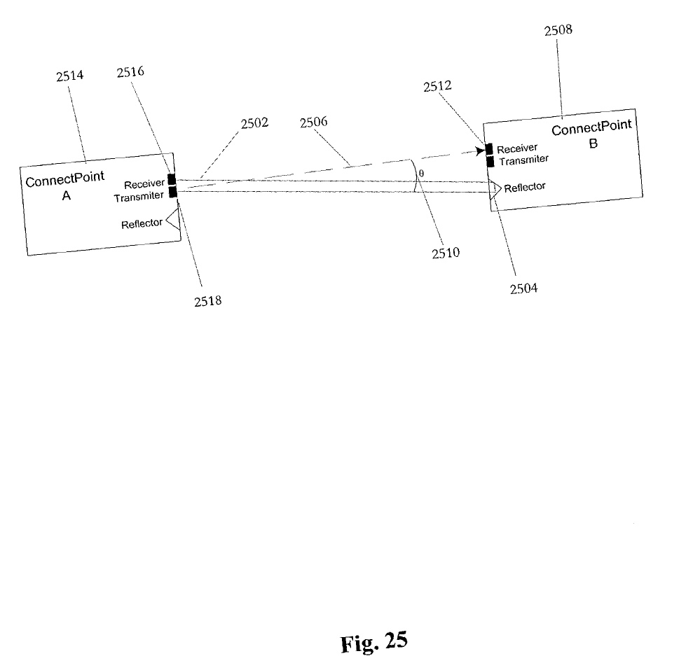

Referring now to FIG. 25, there is shown an embodiment of corner reflector similar to that illustrated in FIG. 24. In the embodiment illustrated in FIG. 25, however, there is additional information provided via received reflection 2502 from a corner reflector 2504 added to the control information transmitted across optical path 2506. A receiving unit 2508 may be able determine the angle 2510, between the reflection and a beam 2506 incident on its detector 2512 using the known distance between the corner reflector 2504 and the receiver 2512. This determination allows the receiving unit 2508 to determine the pointing angle it needs to position its mirror to target the opposite connect unit 2514. The pointing angle can be used during acquisition to more rapidly converge on a detector 2516 of the opposite connect unit.

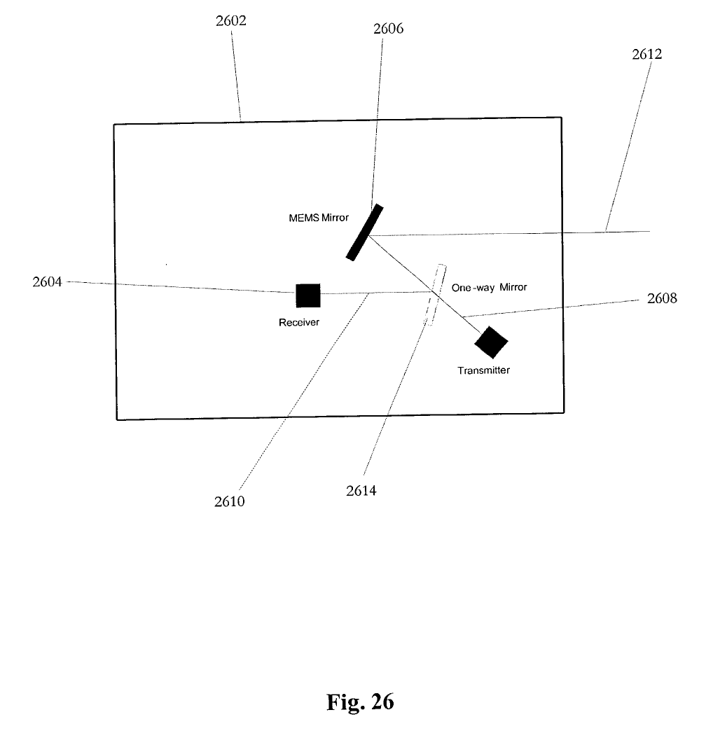

Referring now to FIG. 26, it is noted that when field of view of the receiver 2604 is less than that of a mirror 2606, it is possible for the connect unit 2602 to transmit over a larger area than it can receive. An embodiment of a connect unit 2602 of the optical communications method of the present invention that increases the receive field of view to match the transmit field of view is shown. By using a coincident transmit 2608 beam and a receive 2610, beam 2612, and the mirror 2606, can be used both to steer the transmit beam 2608 out of the device as well as steer the receive beam 2610 to the receiver 2610. The beams 2610 and 2608 may be combined and separated in this embodiment of the present invention using a one-way mirror 2614. This embodiment of the present invention provides a wider field of view to the receiver 2604 and may be particularly useful at higher data rates where the connect units may be used for receiving the optical energy are smaller and have inherently smaller fields of view.

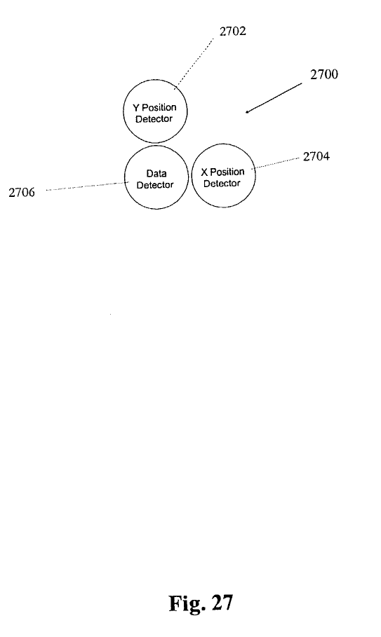

FIG. 27 is a front view of one embodiment of a connect unit 2700 of the optical communications system and method of the present invention. In this embodiment of the present invention, two optional position sensors 2702 and 2704 are used in conjunction with an analog measurement taken from a detector 2706 to enhance pointing accuracy and to address movements and vibrations experienced by the connect unit 2700. The information from the two position sensors 2702 and 2704 is used to supplement the processes described herein that address these issues using a single detector. By comparing the analog measurements of the x-axis detector 2704 with the detector 2706, the x-axis position relative to the detector 2706 is computed. Similarly, the y-axis position is also determined. The use of only two supplemental analog detectors provides lower cost and complexity than the use of a standard quad configuration.

A number of embodiments of the invention have been described. Nevertheless, it will be understood that various modifications may be made without departing from the spirit and scope of the invention. Accordingly, other embodiments are within the scope of the following claims. In the claims, means-plus-function clauses are intended to cover the structures described herein as performing the recited function and not only structural equivalents, but also equivalent structures.

What is claimed is:

1. A method for establishing an optical link for point-to-point high bandwidth communications, comprising the steps of:
transmitting a signal including beam position data from a first optical device to a second optical device;
transmitting a signal including beam position data from the second optical device to the first optical device;
analyzing the beam position data received from the second optical device;
directing a beam through which information can be transmitted between the first optical device and the second optical device based upon the analyzed beam position data;
determining quality of the transmission; and
optimizing the position of the beam on the second optical device based upon the quality of the transmission.

2. The method of claim 1, wherein the beam is a laser.

3. The method of claim 1, wherein the beam is a light-emitting diode (LED).

4. The method of claim 1, wherein the beam does not have uniform energy distribution.

5. The method of claim 2, wherein distance between the first optical device and the second optical device exceeds 100 meters.

6. The method of claim 1, further including the step of providing the information transmitted between the first optical device and the second optical device to an external network.

7. The method of claim 6, wherein the step of providing further includes the step of converting an optical signal into an electrical signal.

8. The method of claim 1, further including the step of acquiring the information to be transmitted between the first optical device and the second optical device to an external network.

9. The method of claim 8, wherein the step of acquiring further includes the step of converting an electrical signal into an optical signal.

10. The method of claim 1, wherein the step of directing a beam further includes the step of positioning a movable mirror based upon the analyzed beam position data to position the beam.

11. The method of claim 1, wherein the steps of transmitting a signal includes the use of control packets.

12. The method of claim 11, wherein the control packets are transmitted via an in-band technique.

13. The method of claim 11, wherein the control packets are transmitted via an out-of-band technique.

14. The method of claim 11, wherein the control packets consist of one or more data fields.

15. The method of claim 14, wherein the data fields are selected from the group consisting of: transmitter identification; recipient identification; control packet version; status information; sequence number; received quality measurements; received mirror position information; control packet error counts; and performance of lower transport layers.

16. The method of claim 1, wherein the step of determining the quality of the transmission includes the use of a rolling weighted averages.

17. The method of claim 1, wherein the step of determining the quality of the transmission includes the step of using calculations completed by the first optical device about the quality of the transmission at the first optical device.

18. The method of claim 1, wherein the step of determining the quality of the transmission includes the step of using calculations completed by the second optical device about the quality of the transmission at the second optical device.

19. The method of claim 1, wherein the step of directing a beam includes the use of a registration pattern.

20. The method of claim 1, wherein the step of directing a beam further includes the steps of:
drawing a registration pattern;
transmitting quality and position data with the registration pattern;
initiating a sample period;
analyzing receive data; and
adjusting the registration pattern based upon the analyzed receive data.

21. The method of claim 20, wherein the registration pattern is of a type selected from the group consisting of: spiral, crossbar and matrix.

22. The method of claim 1, wherein the step of optimizing the position of the beam on the second optical device based upon the quality of the transmission further comprises the steps of:
sending transmission quality data from the first optical device to the second optical device at a predetermined rate;
receiving transmission quality data from the second optical device at a predetermined rate;
analyzing the transmission quality data from the second optical device to determine quality of alignment of the beam; and
realigning the beam to optimize the communications link in response to the analyzed transmission quality data.

23. The method of claim 1, wherein the step of determining quality of transmission includes the use of estimation.

24. The method of claim 1, wherein the step of determining quality of transmission includes the use of direct measurement.

25. A method for establishing an optical link for point-to-point high bandwidth communications, comprising the steps of:
directing a beam through which information can be passed from a first optical device to a second optical device;
said information including pointing data and quality data associated with the beam at the first optical device
acquiring the beam by the second optical device.
analyzing the pointing data and the quality data; and
optimizing position of the beam on the second optical device based upon the analyzed pointing data and quality data.

26. The method of claim 25, wherein the step of directing a beam includes the use of a registration pattern.

27. The method of claim 26, wherein the registration pattern is of a type selected from the group consisting of: spiral, crossbar and matrix.

28. The method of claim 25, wherein the step of analyzing the position data and the quality data includes the use of weighted data quality calculations.

29. The method of claim 25, further including the step of monitoring drift of the beam over time to calculate drift data.

30. The method of claim 29, further including the step of correcting the drift using the drift data.

31. The method of claim 25, wherein the beam is a laser.

32. The method of claim 25, wherein the beam is a light-emitting diode (LED).

33. The method of claim 25, wherein the beam does not have uniform energy distribution.

34. The method of claim 25 further including a step of estimating the distance between the first optical device and the second optical device.

35. The method of claim 34, wherein the distance is estimated by calculating the different in pointing angles of the first optical device and the second optical device.

36. The method of claim 25, wherein distance between the first optical device and the second optical device is greater than 100 meters.

37. The method of claim 25, wherein the step of acquiring the beam includes the step of locking on only the second optical device and ignoring any other optical devices within a field of view (FOV).

38. The method of claim 25, wherein the step of directing a beam through which information can be passed from a first optical device to a second optical device further includes the step of estimating the pointing data and the quality data.

39. The method of claim 25, wherein the step of directing a beam through which information can be passed from a first optical device to a second optical device further includes the step of directly measuring the pointing data and the quality data.

40. A system for establishing an optical link for point-to-point high bandwidth communications, comprising:
means for transmitting a signal including beam position data from a first optical device to a second optical device;
means for transmitting a signal including beam position data from the second optical device to the first optical device;
means for analyzing the beam position data received from the second optical device;
means for directing a beam through which information can be transmitted between the first optical device to the second optical device based upon the analyzed beam position data;
means for determining quality of transmission; and
means for optimizing the position of the beam on the second optical device based upon the analyzed quality of transmission.

41. The system of claim 40, wherein the means for transmitting the signals are optical devices each having an optical transmitter and receiver, enabling bidirectional data flow between the first optical device and the second optical device.

42. The system of claim 40, wherein the means for directing a beam is a dynamic mirror.

43. The system of claim 40, wherein the optical devices include an electrical interface for external communications.

44. The system of claim 40, wherein the means for directing a beam includes at least one signal processor for system management and beam pointing.

45. The system of claim 41, wherein the transmitter and the receiver of the optical devices are combined to expand a field of regard for the system.

46. The system of claim 40, further including means for monitoring and measuring pointing angles.

47. The system of claim 46, further including means to adjust location of the beam in response to the measured pointing angles.

48. The system of claim 40, further including means for automatically aligning the beam.

49. The system of claim 48, wherein the means for automatically aligning is a movable reflective device.

50. The system of claim 40, wherein the means for determining quality of transmission includes means for estimating.

51. The system of claim 40, wherein the means for determining quality of transmission includes means for direct measurement.
